(19) United States
(12) Patent Application Publication
(10) Pub. No.: US 2009/0017812 A1
(43) Pub. Date: Jan. 15, 2009

(54) Method and system for restoring user settings after over-the-air update of mobile electronic device software

(76) Inventors: Weng Chong Chan, Tigard, OR (US); Atsushi Ishli, Vancouver, WA (US)

Correspondence Address: SHARP LABORATORIES OF AMERICA, INC., 1320 PEARL ST., SUITE 228, BOULDER, CO, 80302, US

(21) Appl. No.: 11/827,235

(22) Filed: Jul. 11, 2007

(51) Int. Cl. H04M 3/00

(52) U.S. Cl. 455/419

(57) ABSTRACT

Method and system for restoring user selections of device settings after an over-the-air update of mobile electronic device software. A restoration package is installed on a mobile electronic device after installation on the device of a software update package, resulting in automatic restoration transparent to the user of any user selections of device settings that may have been modified during installation of the software update package.

### BACKGROUND OF THE INVENTION

The present invention relates to mobile electronic devices and, more particularly, to mobile electronic devices that receive over-the-air software updates.

Mobile electronic devices, such as cellular phones, personal data assistants (PDAs) and pocket PCs, are becoming increasingly sophisticated. This increased sophistication has brought with it more complex software and a higher incidence of coding errors, called software bugs. This increased sophistication has also led to more frequent availability of software upgrades that enhance the functionality of such devices. To remove software bugs and enable software upgrades, software updates are disseminated and installed on such devices.

To more efficiently distribute software updates to a large installed base of mobile electronic devices, techniques that download software updates to such devices over the air have been deployed. In such wireless download schemes, a software update is typically loaded on a software update server in a network infrastructure and is pushed or pulled from the server to a plurality of such devices.

A technical challenge that arises during over-the-air software updates is how to update device settings without disturbing user selections. A software image on a mobile electronic device typically includes device settings that affect, for example, how the device interfaces with the user. These device settings are often initialized to default selections that a user of the device can modify to match his or her preferences. Unfortunately, conventional software update servers generally do not know which default selections a user has modified. Without such knowledge, there is no way to perform a selective update of device settings via an over-the-air software update that preserves only the user selections. If device settings are globally updated as part of the software update, the user selections are overwritten and the user must then once again modify the device settings to match his or her preferences, consuming the user's time and causing frustration. On the other hand, if device settings are not updated as part of a software update, the device may not perform at a desired level after the update. Old device settings that are no longer required will persist, new device settings that are required by the updated software will not become operative and default selections will not be optimized for the updated software. Incompatibilities between the updated software and old device settings may even render the device inoperative.

One proposed technique to address this technical challenge is described in Helvick U.S. application Ser. No. 11/371,843 entitled “Mobile Electronic Device with Fragmented Device Settings,” which is assigned to the assignee hereof. The technique proposed by Helvick fragments device settings into default setting and user setting pairs that are separately maintained, referenced and updated. Default settings store initial device settings while user settings store user-selected device settings. Default settings are updated in response to software updates but are not updated in response to user selections, whereas user settings are updated in response to user selections but are not updated in response to software updates. User preferences are thus preserved during software updates.

While the technique proposed by Helvick has numerous advantages, certain complications arise from the fragmentation of device settings. The device must enforce rules to determine whether a default setting or a user setting is returned in response to a given interrogation of a device setting. Additionally, in order to maintain alignment between default setting and user setting pairs, device settings rendered obsolete by a software update must be retained or else the device must include a program that executes after software updates to restore alignment.

### SUMMARY OF THE INVENTION

The present invention, in a basic feature, preserves user selections within device settings after an over-the-air update of mobile electronic device software. Generally speaking, preservation of user selections is achieved through installation on a mobile electronic device of a restoration package after installation on the device of a software update package, resulting in automatic restoration transparent to the user of any user selections within device settings that may have been modified during installation of the software update package.

In one aspect, the present invention provides a mobile electronic device having a memory adapted to store a device setting and a restoration package, a wireless interface adapted to receive a software update package and a processor communicatively coupled with the wireless interface and the memory and adapted to execute the software update package whereby the device setting is initialized to a default selection and adapted to execute the restoration package whereby the device setting is restored to a user selection.

In another aspect, the present invention provides a method for restoring a device setting after an over-the-air update of mobile electronic device software comprising the steps of receiving over the air a software update package, executing the software update package whereby a device setting is initialized to a default selection and executing a restoration package whereby the device setting is restored to a user selection.

In another aspect, the present invention provides a method for restoring a device setting after an over-the-air update of mobile electronic device software, comprising the steps of changing a device setting from a first default selection to a user selection via a user input, changing the device setting from the user selection to a second default selection by executing an over-the-air software update and changing the device setting from the second default selection to the user selection by executing restoration software.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a communication network in one embodiment of the invention.

FIG. 2 shows a mobile electronic device in one embodiment of the invention.

FIG. 3 shows a non-volatile memory in one embodiment of the invention.

FIGS. 4A through 4C show exemplary screens rendered on a user interface of a mobile electronic device in one embodiment of the invention.

FIG. 5 is a flow diagram showing a method for restoring a device setting to a user selection after an over-the-air update of mobile electronic device software in one embodiment of the invention.

FIG. 6 is a flow diagram showing a method for restoring a device setting to a user selection after an over-the-air update of mobile electronic device software in another embodiment of the invention.

### DETAILED DESCRIPTION OF A PREFERRED EMBODIMENT

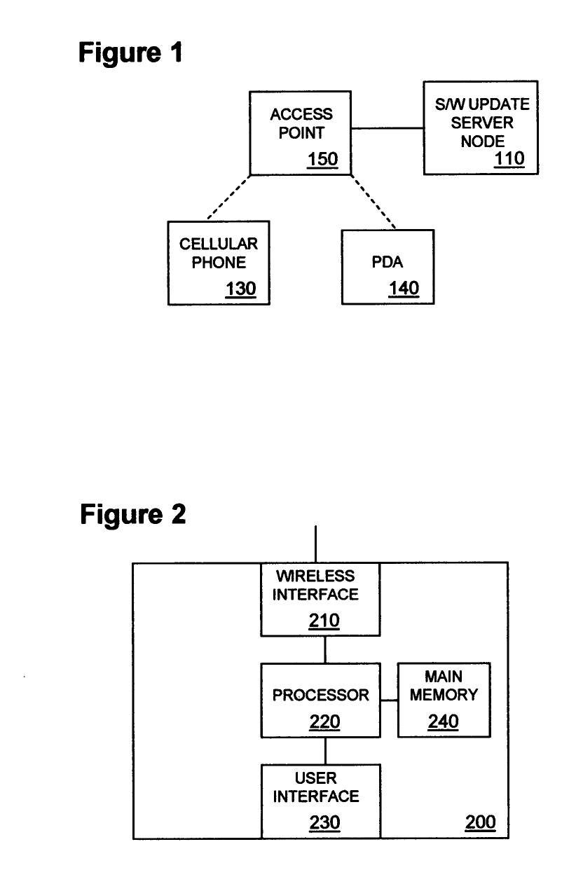

In FIG. 1, a communication network in which the present invention is operative in one embodiment is shown. The network includes a software update server node 110 in a network infrastructure. Server node 110 may reside in an enterprise network or a service provider network, for example. Server node 110 has wired connectivity with an access point 150, such as a cellular base station or a wireless LAN access point. The connectivity may be direct or via one or more intervening data communication nodes, such as routers, switches and bridges. Access point 150 has wireless connectivity with a plurality of mobile electronic devices 130, 140 via respective over-the-air links. The over-the-air links may include various types of wireless links over which data may be transmitted, such as cellular links and wireless LAN links. Mobile electronic devices 130, 140 shown include a cellular phone 130 and a PDA 140, although other types of devices having a wireless interface, for example, pocket PCs, may be deployed. In other embodiments, the mobile electronic devices in the network may be homogenous, that is, all devices may fit within the same product class (e.g. cell phones).

Server node 110 stores and distributes software updates to an installed base of mobile electronic devices, such as devices 130, 140. The installed base may include, for example, a group of mobile electronic devices owned by a common enterprise or used by a subscriber group. Software update types include, for example, patches with corrective code and upgrades with code that supports new features or functionality. Device settings on mobile electronic devices are updated attendant to software updates. In some embodiments, server node 110 prepares and downloads to mobile electronic devices delta packages reflective of differences between current versions of software running on mobile electronic devices and replacement versions of software to be installed on mobile electronic devices. In such embodiments, server node 110 compares the current version of software running on a mobile electronic device with a replacement version of software stored on server node 110 to determine an update path and uses the update path to generate an appropriate delta package for the mobile electronic device. The mobile electronic device receives the delta package from server node 110 and executes the delta package to update to the replacement version. In some embodiments, software updates are pulled from server node 110 pursuant to requests made by devices 130, 140. In other embodiments, software updates are pushed by server node 110 to devices 130, 140 independent of any request.

Turning to FIG. 2, a mobile electronic device 200 in one embodiment of the invention is shown. Device 200 includes a wireless interface 210 adapted to transmit and receive data in accordance with a wireless communication protocol, such as a cellular or wireless LAN protocol. Device 200 further includes a user interface 230 adapted to transmit outputs and receive inputs from a user of device 200. User interface may, for example, include an output mechanism such as a liquid crystal display (LCD) and a mechanism for receiving user input such as a keypad or touch-sensitive navigation tool. Device 200 further includes a main memory 240 adapted to store device software and settings. Memory 240 includes a non-volatile memory. Device 200 further includes a processor 220 adapted to execute device software stored in main memory 240 and interoperate with elements 210, 230, 240 to perform various features and functions supported by device 200, including the method and system for restoring user selections after an over-the-air update of mobile electronic device software described herein.

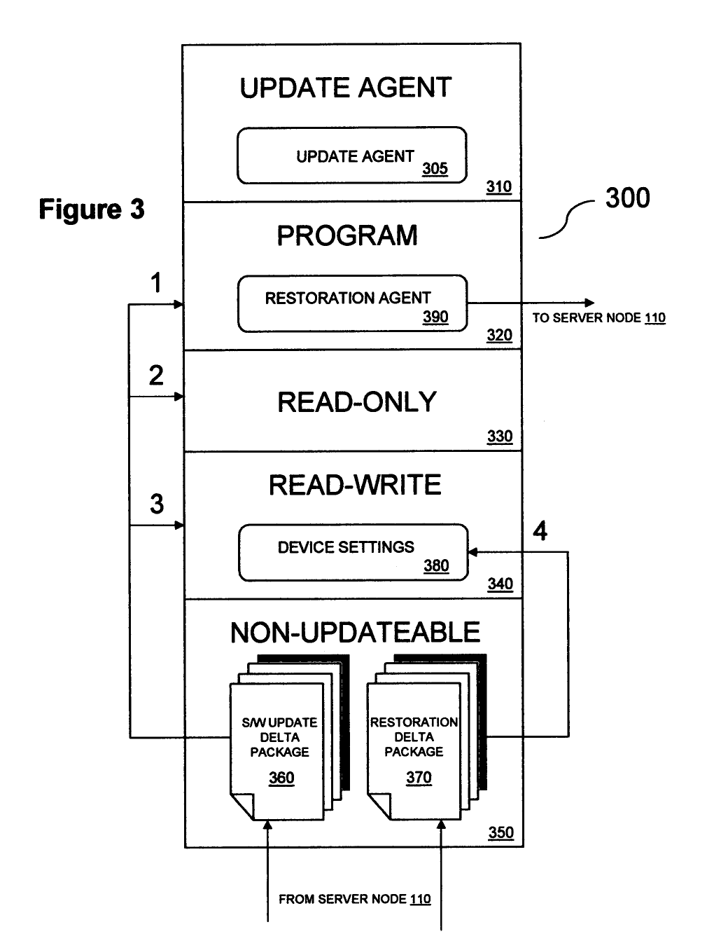

Turning to FIG. 3, a non-volatile memory 300 for a system for restoring device settings to user selections after an over-the-air update of mobile electronic device software in one embodiment of the invention is shown. Non-volatile memory 300 may be a flash memory, for example. Memory 300 has multiple areas that together store the complete executable software image on device 200. The areas include an update agent area 310, a program area 320, a read-only data area 330, a read-write data area 340 and a non-updateable area 350. An update agent 305 is stored in updated agent area 310. A restoration agent 390 is stored in program area 320. Agents 305, 390 are software programs having instructions executable by processor 220 to perform their respective functions. Device settings 380 are stored in read-write data area 340. Finally, a software update delta package 360 and a restoration delta package 370 are stored in non-updateable area 350.

In operation, restoration agent 390 continually monitors device 200 for changes to device settings mode through user inputs on user interface 230 and for impending downloads of software updates from server node 110. Device settings monitored by restoration agent 390 may affect display language, ring tone properties, backlight properties, screen saver properties and security, for example, of device 200. In some embodiments, whenever restoration agent 390 detects a change to a monitored device setting, restoration agent 390 stores information indicative of the change in a device setting change log. The stored information may include an identity of the affected device setting and the user selection for the affected device setting, for example. Then, whenever restoration agent 390 detects that a download of a software update from server node 110 is about to begin, restoration agent 390 transmits the contents of the device setting change log to server node 110. Server node 110 uses the device setting change log contents and the determined software update path for device 200 to generate restoration delta package 370, which server node 110 transmits to device 200 along with software update delta package 360. In some embodiments, restoration agent 390 flushes the device setting change log after each software update.

In other embodiments, the device setting change log is obviated. In these embodiments, whenever restoration agent 390 detects that a download of a software update from server node 110 is about to begin, restoration agent 390 determines changes to device settings 380 by comparing current selections of device settings 380 with default selections of device settings 380 retained in memory 300 and transmits information indicative of the differences to server node 110.

When installing a software update, update agent 305 executes software update delta package 360, which first updates program area 320, then updates read-only area 330 and finally updates read-write area 340 including device settings 380. The update of device settings 380 initializes device settings 380 to default selections defined by the software update. The default selections defined by the software update may be the same or different than the default selections defined by the replaced software and may be the same or different than selections made by the user through inputs on user interface 230. In any event, to restore the user selections, update agent 305 executes restoration delta package 370 after execution of the software update delta package 360. Execution of restoration delta package 370 restores the user selections of device settings 380 that were modified attendant to execution of the software update delta package 360. Update agent 305 then causes device 200 to reboot under the updated software regime.

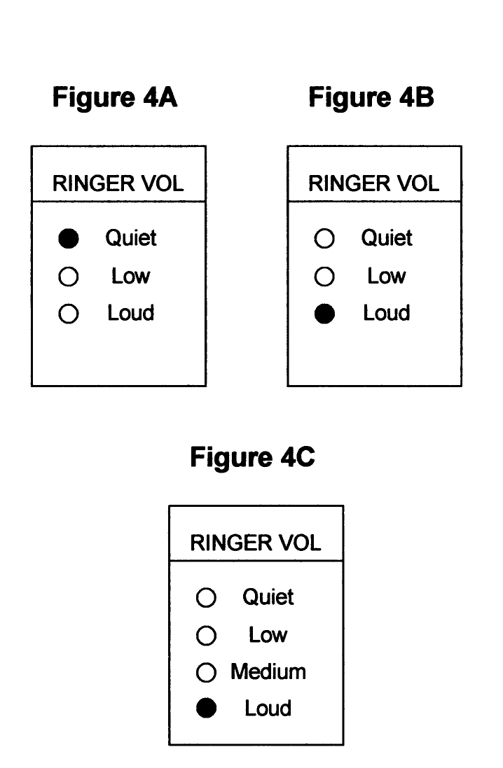

In FIGS. 4A through 4C, exemplary screens rendered on user interface 230 in one embodiment of the invention are shown. The screens represent three sequential states of a device setting, more particularly a ring tone volume setting, on mobile electronic device 200. Turning first to FIG. 4A, a ring tone volume setting state before installation of a software update and before input of a user selection is shown. The ring tone volume setting includes three selectable options, “Quiet”, “Low” and “Loud”. The default option “Quiet” is currently selected. Turning to FIG. 4B, a ring tone volume setting state after subsequent input of a user selection is shown. The ring tone volume setting includes three selectable options, “Quiet”, “Low” and “Loud”. The user-selected option “Loud” is currently selected. This reflects a selection of “Loud” made by a user of device 200 through an input on user interface 230. Finally, in FIG. 4C, a ring tone volume setting state after subsequent installation of a software update is shown. The ring tone volume setting now includes four selectable options, “Quiet”, “Low”, “Medium” and “Loud”. This reflects the addition of the selectable option “Medium” as a result of installation of the software update. Notwithstanding the software update, however, the user-selected option “Loud” remains currently selected. This reflects the automatic restoration via execution of restoration delta package 370, transparent to the user, of the user-selected option “Loud” after execution of software update delta package 360. It will be appreciated that without such automatic restoration, modification of the user-selected option “Loud” with the default option “Quiet” via execution of software update delta package 360 would not have been reversed, requiring the user to manually intervene to restore his or her ring tone volume preference.

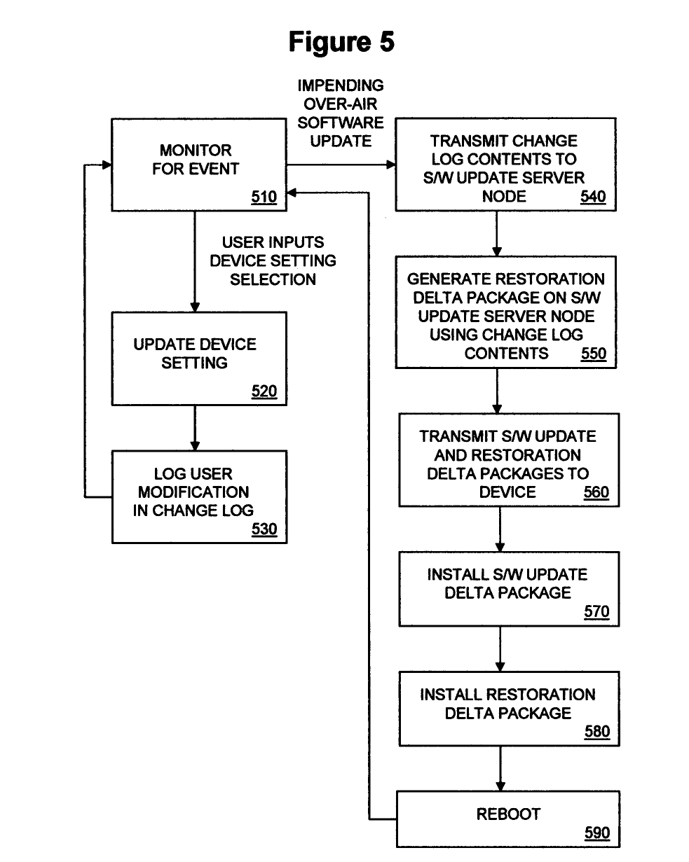

Turning to FIG. 5, a flow diagram shows a method for restoring device settings to user selections after an over-the-air update of mobile electronic device software in one embodiment of the invention. The flow starts with restoration agent 390 monitoring for an event (510). Generally speaking, restoration agent 390 monitors for two types of events: (1) device setting changes made by user input and (2) impending software update downloads. If the next detected event is a device setting change, the device setting is updated on device 200 (520) and logged in a device setting change log on device 200 (530). If the next event is an impending software update download, device 200 transmits the contents of the device setting change log to software update server node 110 (540). Software update server node 110 generates restoration delta package 370 using the change log contents and its knowledge of the update path (550) and downloads software update delta package 360 and restoration delta package 370 to device 200 (560), whereupon packages 360, 370 are stored in non-updateable area 350 of non-volatile memory 300. Update agent 305 then executes software update delta package 360 (570), resulting in installation of the software update, and also resulting in user selections within device settings 380 being overwritten with default selections defined by the software update. Update agent 305 then executes restoration delta package 370 (580), resulting in the restoration of user selections within device settings 380. Update agent 305 then reboots device 200 (590), whereupon device 200 runs under the new software regime.

As explained earlier, in other embodiments the logging function is not performed. In these embodiments, device 200 determines device setting changes without reference to a change log and transmits information indicative of the device setting changes from which software update server node 110 generates restoration delta package 370.

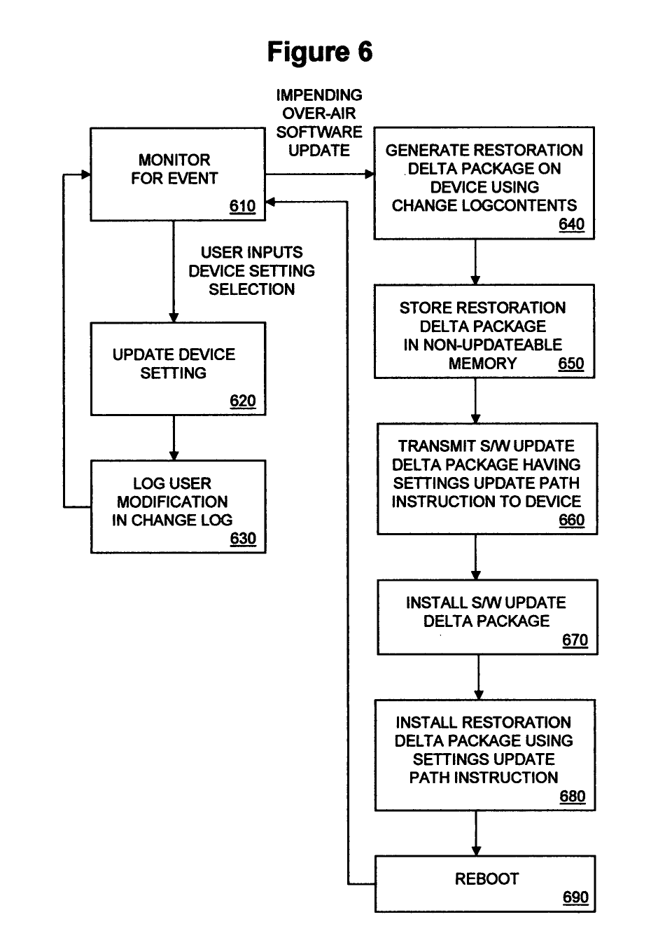

Turning to FIG. 6, a method and system for restoring user-configured device setting values after an over-the-air update of mobile electronic device software in another embodiment of the invention is shown. This embodiment does not require the mobile electronic device to send information indicative of device setting changes to the software update server node. The flow again starts with a restoration agent on the device monitoring for an event (610). If the next detected event is a device setting value change, the device setting value is updated on the device (620) and logged in a device setting change log on the device (630). If the next event is an impending software update download, the device generates a restoration delta package using the contents of the device setting change log (640) and stores the restoration delta package in a non-updateable area of a non-volatile memory on the device (650). It will be appreciated that the restoration delta package in this embodiment is created without knowledge of the update path. To correct this deficiency, software update server node downloads to the device a software update delta package that has a settings update path instruction (660), which software update delta package is stored in the non-updateable area of the non-volatile memory. An update agent on the device then executes the software update delta package (670), resulting in installation of the software update, but also resulting in user selections within the device settings being overwritten with default selections defined by the software update. In executing the software update delta package, the update agent learns the update path for the device settings from the settings update path instruction. The update agent then executes the restoration delta package and, applying knowledge of the update path acquired from the settings update path instruction, restores user selections within the device settings (680). The update agent then reboots the device (690), whereupon the device runs under the new software regime.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A mobile electronic device, comprising:
a memory adapted to store a device setting and a restoration package;
a wireless interface adapted to receive a software update package; and
a processor communicatively coupled with the wireless interface and the memory and adapted to execute the software update package whereby the device setting is initialized to a default selection and adapted to execute the restoration package whereby the device setting is restored to a user selection.

2. The mobile electronic device of claim 1 wherein the processor is further adapted to detect user selection of a device setting.

3. The mobile electronic device of claim 2, wherein the processor is further adapted to detect an impending over-the-air software update.

4. The mobile electronic device of claim 3, wherein the processor is further adapted in response to detection of the impending over-the-air software update to transmit to a server node via the wireless interface information indicative of a device setting change.

5. The mobile electronic device of claim 4, wherein the processor is further adapted to receive from the server node via the wireless interface the software update package and the restoration package, and wherein the restoration package is created based at least in part on the information indicative of the device setting change.

6. The mobile electronic device of claim 3, wherein in response to detection of the impending over-the-air software update the processor is further adapted to create the restoration package based at least in part on information indicative of a device setting change.

7. The mobile electronic device of claim 1, wherein the memory is a non-volatile memory.

8. A method for restoring a device setting after an over-the-air update of mobile electronic device software, comprising the steps of:
receiving over the air a software update package;
executing the software update package whereby a device setting is initialized to a default selection; and
executing a restoration package whereby the device setting is restored to a user selection.

9. The method of claim 8, further comprising the step of:
detecting user selection of a device setting; and

10. The method of claim 9, further comprising the step of:
detecting an impending over-the-air software update.

11. The method of claim 10, further comprising the step of:
transmitting to a server node via the wireless interface in response to detection of the impending over-the-air software update information indicative of a device setting change.

12. The method of claim 11, further comprising the step of:
receiving from the server node via the wireless interface the software update package and the restoration package, wherein the restoration package is created based at least in part on information indicative of the device setting change.

13. The method of claim 10, further comprising the step of:
creating in response to detection of the impending over-the-air software update the restoration package based at least in part on information indicative of the device setting change.

14. A method for restoring a device setting after an over-the-air update of mobile electronic device software, comprising the steps of:
changing a device setting from a first default selection to a user selection via a user input;
changing the device setting value from the user selection to a second default selection by executing an over-the-air software update; and
changing the device setting from the second default selection to the user selection by executing restoration software.

15. The method of claim 14, wherein the step of changing the device setting from the user selection to the second default selection comprises the steps of:
generating on a server node a software update package;
transmitting over the air by the server node to a mobile electronic device the software update package; and
executing on the mobile electronic device the software update package.

16. The method of claim 14, wherein the step of changing the device setting from the second default selection to the user selection comprises the steps of:
transmitting over the air by a mobile electronic device to the server node information indicative of a change to the device setting;
generating on the server node a restoration package using the information indicative of the change to the device setting;
transmitting over the air by the server node to the mobile electronic device the restoration package; and
executing on the mobile electronic device the restoration package.

17. The method of claim 14, wherein the step of changing the device setting from the second default selection to the user selection comprises the steps of:
generating on a mobile electronic device a restoration package; and
executing on the mobile electronic device the restoration package.

18. The method of claim 14, wherein the first and second default selections are the some.

19. The method of claim 14, wherein the first and second default selections are different.
